(19) United States
(12) Patent Application Publication
(10) Pub. No.: US 2007/0016318 A1
(43) Pub. Date: Jan. 18, 2007

(54) Systems and methods for determining production availability

(76) Inventors: Wei-Yao Lin, Toufen Town (TW); Rebecca Hsu, Shin Chu City (TW); Yun-Tzu Chiu, Campbell, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/182,722

(22) Filed: Jul. 15, 2005

(51) Int. Cl. G06F 19/00

(52) U.S. Cl. 700/97; 700/99

(57) ABSTRACT

A system for managing production availability. A storage device stores a production entry corresponding to a client for production using a particular technology. The production entry comprises a demand profile and a production availability profile. The demand profile specifies the amount of capacity allocated support demand (CASD) for the client during a preset period, comprising a non-booked CASD and a booked CASD. The production availability profile specifies available-to-promise (ATP) production corresponding to the non-booked CASD, comprising production values specifying quantities of ATP production allocated to the client during different divisions of the preset period. The processor, connected to the storage device, updates an existing production availability profile according to an existing demand profile, wherein the production values of the updated production availability profile are determined according to the existing CASD profile and ratios of the production values of the existing production availability profile.

### BACKGROUND

The present invention relates to resource planning and more particularly to systems and methods for determining production availability in a manufacturing environment.

In a complex manufacturing environment such as a semiconductor manufacturing environment, it is difficult to determine production availability. Currently existing planning tools used for determining production availability include spreadsheets, manual calculations, and software-implemented calculations. Spreadsheets are commonly used to combine supply and demand information for managing production availability, and for making reasonably accurate product forecasts. Further, manually doing the same task is even more difficult.

According to a conventional method, production availability calculation is performed periodically, for example, once a month. Additionally, the production availability calculation processes information pertaining to all unfilled demands. For example, when an order is placed for product A on May 15, year X, a client cannot know an available-to-promise (ATP) production corresponding to the order until June 1, year X. If the capacity-allocated support demand (CASD) corresponding to the client is changed by an operator of a manufacturing system on June 15, year X, again, the ATP production corresponding thereto cannot be known until July 1, year X. As described, a conventional ATP production management system performs ATP production checks periodically, and clients must wait for the next run to obtain an ATP production value corresponding to submitted orders. Additionally, the ATP production checking process determines ATP production for all unfilled demands comprising non-booked and booked CASD, and thus substantial computing resources are required.

### SUMMARY

The invention provides, a system for managing production availability. A storage device stores a production entry corresponding to a client for production using a particular technology. The production entry comprises a demand profile and a production availability profile. The demand profile specifies amount of capacity allocated support demand (CASD) for a client during a preset period, comprising non-booked CASD and booked CASD. The production availability profile specifies available-to-promise (ATP) production corresponding to the non-booked CASD, comprising production values specifying quantities of ATP production allocated to the client during different divisions of the preset period. The processor, connected to the storage device, updates an existing production availability profile according to an existing demand profile, wherein the production values of an updated production availability profile are determined according to the existing CASD profile and ratios of the production values of the existing production availability profile.

A method for updating production availability is also provided. A production entry corresponding to a client for production using a particular technology is provided. The production entry comprises a demand profile and a production availability profile. The demand profile specifies amount of capacity allocated support demand (CASD) for the client during a preset period, comprising a non-booked CASD and a booked CASD. The production availability profile specifies available-to-promise (ATP) production corresponding to the non-booked CASD, comprising production values specifying quantities of ATP production allocated to the client during different divisions of the preset period. An existing production availability profile is updated according to an existing demand profile, wherein the production values of an updated production availability profile are determined according to the existing CASD profile and ratios of the production values of the existing production availability profile.

The method may take the form of program code embodied in a tangible media. When the program code is loaded into and executed by a machine, the machine becomes an apparatus for practicing the method.

### DESCRIPTION OF THE DRAWINGS

The invention can be more fully understood by reading the subsequent detailed description and examples with references made to the accompanying drawings, wherein:

FIG. 1 is a schematic view of an embodiment of a manufacturing system implementing production availability management;

FIG. 2 is a schematic view of an embodiment of the ATP determining device of FIG. 1;

FIG. 3 is a flowchart of an embodiment of a method of production availability management system of the invention;

FIGS. 4A˜4C illustrate CASD and ATP information generated in an embodiment of a production availability management method; and

FIG. 5 is a diagram of a storage medium storing a computer program providing an embodiment of a production availability management method.

### DETAILED DESCRIPTION

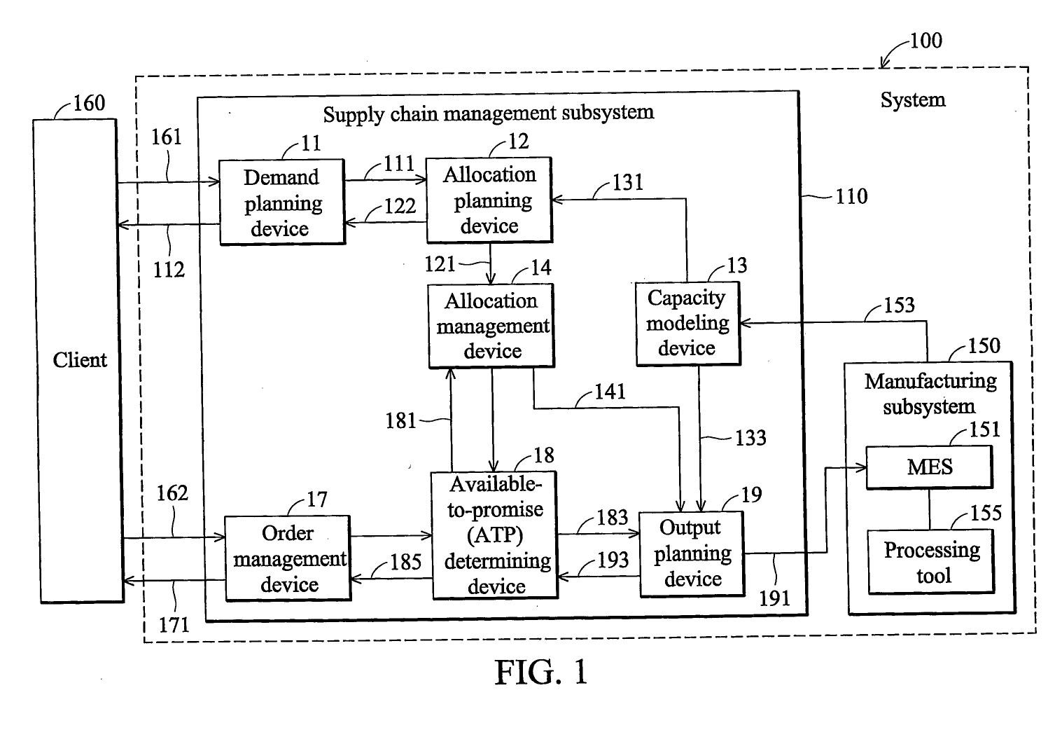

A exemplary embodiment of the invention will now be described with reference to FIGS. 1 through 5, which generally relate to supply chain management in a manufacturing environment. While some embodiments of the invention are applied to semiconductor manufacturing, it is understood that other manufacturing systems may be readily substituted.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 1 is a schematic view of an embodiment of a manufacturing system implementing production availability management. Specifically, a system 100 is a semiconductor manufacturing system, comprising a supply chain management subsystem 110 and a manufacturing subsystem 150. The manufacturing subsystem 150 comprises a manufacturing executive system (MES) 151 and at least one processing tool 155. The manufacturing subsystem 150 provides capacity information from a plurality of processing tools to the supply chain management subsystem 110 according to a master production plan (MPS), operates to fulfill production requests determined by the supply chain management subsystem 110.

The supply chain management subsystem 110 comprises a demand planning device 11, allocation planning device 12, capacity modeling device 13, allocation management device 14, order management device 17, available-to-promise (ATP) determining device 18, and output planning device 19. The demand planning device 11 receives demand forecast 161 from a client 160. The demand forecast 161 specifies forecasted production of a particular technology required by client 160 in a predetermined period of time. For example, the demand forecast 161 can specify 1000-wafer production for 0.18 micron technology in a particular month. The demand forecast 161 provided by the client 160 is adjusted by the demand planning device 11. The demand forecast adjustment is performed according to a historical demand record of a corresponding client, market analysis information, and other information. Adjusted demand forecast 111 is sent to an allocation planning device 12. The allocation planning device 12 receives a capacity plan 131 from the capacity modeling device 13. The capacity plan 131 is generated by the capacity modeling device 13 according to capacity information 153 provided by the manufacturing subsystem 150. The allocation planning device 12 determines a capacity-allocated-support demand (CASD) 121 according to the received capacity plan 131 and the adjusted demand forecast 111. The allocation planning device 12 also generates a support plan 122 according to the received capacity plan 131 and the adjusted demand forecast 111. Typically, the support plan 122 specifies production amount that can be supported by the manufacturing subsystem 150 over a relatively long-term period, for example, 18 months. The CASD 121 is sent to the allocation management device 14. The support plan 122 is sent to the demand planning device 11, and a support commitment 112 is generated accordingly. The support commitment 112 is then sent to the client 160.

When a purchase order 162 is placed by the client 160, the purchase order 162 is received by the order management device 17. The management device 17 sends the purchase order 162 to the available-to-promise (ATP) determining device 18. The ATP determining device 18 receives information pertaining to the purchase order 162 transmitted from the order management device 17, and determines the amount of CASD booked for the purchase order 162 and ATP production consumed for the purchase order 162. The ATP determining device 18 then sends information pertaining to booked-CASD 181 to the allocation management device 14. The allocation management device 14 receives the booked-CASD 181 and adjusts the original CASD accordingly. The ATP determining device 18 also sends information pertaining to consumed ATP production 183 to the output planning device 19. The output planning device 19 receives the consumed ATP production 183 from the ATP determining device 18, receives a capacity plan 133 from the capacity modeling device 13, and operative to generate a master production schedule (MPS) 191 accordingly and sends it to the MES 151 of the manufacturing subsystem 150. The MES 151 directs operation of the processing tool 155 according to the received MPS 191. The output planning device 19 receives adjusted CASD 141 from the allocation management device 14, and operative to generate a new ATP production plan 193. The new ATP production plan is then sent to the ATP determining device 18. Upon receiving the new ATP production plan 191 received from the output planning device 19 the ATP determining device 18 operative to generate a production availability profile 185. The production availability profile 185 is sent to the order management device 17. The order management device 17 generates delivery confirmation 171 corresponding to the purchase order 162 according to the production availability profile 185. The delivery confirmation 171 is then presented to the client 160 by the order management device 17.

Typically, the output planning device 19 updates the production availability profile periodically, for example, once a month. The production availability profile specifies available-to-promise (ATP) production corresponding to non-booked CASD, comprising production values specifying quantities of ATP production allocated to the client 160 during different divisions of the preset period. For example, a production availability profile comprises 4 production values corresponding to the weeks 1˜4 of a particular month. When a production availability profile is required, the production availability profile is updated according to the CASD profile. The production values of the updated production availability profile are determined according to ratios of the production values of the existing production availability profile and the CASD profile. The described process performed by the ATP determining device 18 operates whenever a request is placed. The details of the ATP determining device 18 and the operation performed thereby are described in the following.

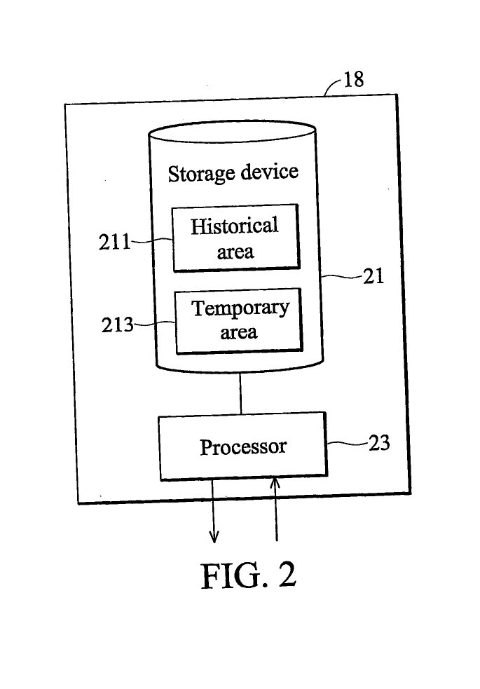

FIG. 2 is a schematic view of an embodiment of the ATP determining device of the FIG. 1. The ATP determining device 18 comprises a storage device 21 and a processor 23. The processor 23 receives a production availability profile request from the client 160 via the order management device 17. In response to the request, the ATP determining device 18 retrieves a CASD profile from the allocation management device 14, and retrieves a corresponding production availability profile. Generally, the contents of the production availability profile conform to the CASD profile. In some circumstances, however, the CASD profile may be changed by an operator of a manufacturing system based on a business strategy or other concern. For example, client 160 is allocated a CASD of 1000 wafers, and places a purchase order of 500 wafers. Half of the CASD, i.e., 500 wafers, is booked for the purchase order. There is no purchase order being placed corresponding to the non-booked CASD. Therefore, it is determined that the non-booked CASD allocated to the client 160 is to be reduced to 250. The output planning device 19 updates the production availability profile according to the changed CASD profile on a preset ATP checking day. Before the periodical ATP check is performed, the contents of the production availability profile do not conform to the CASD profile. Additionally, the ATP determining device performs an ATP check whenever a request is submitted.

The storage device 21 comprises a historical area 211 and a temporary area 213, wherein the historical area 211 stores a historical record of a production entry, and the temporary area 213 stores temporary data used in an ATP updating process. Each production entry corresponds to a client for production of a particular technology. The production entry comprises a demand profile and a production availability profile. The demand profile specifies the amount of capacity allocated support demand (CASD) for the client during a preset period, for example, a month. The CASD profile comprises a non-booked CASD value and a booked CASD value, wherein the booked-CASD value specifies a CASD booked for a placed purchase order. The production availability profile specifies available-to-promise (ATP) production corresponding to the non-booked CASD, comprising production values specifying quantities of ATP production allocated to the client during different divisions of the predetermined period. For example, a production value specifies the amount of ATP production allocated to the client during a week within a month.

The processor 23 is connected to the storage device 21. The processor 23 updates the production availability profile in response to a changed CASD profile, wherein the production values of the updated production availability profile are determined according to ratios of the production values of the existing production availability profile and the existing CASD profile.

If a request for a production availability profile is received during the ATP updating process, the production availability profile stored in the historical area 211 is provided in response to the request. When the updated production availability profile is determined, it is stored in the temporary area 213, and then copied to the historical area 211. If a request for a production availability profile is received after the updated production availability profile is copied to the historical area 211, the updated production availability profile is provided in response to the request.

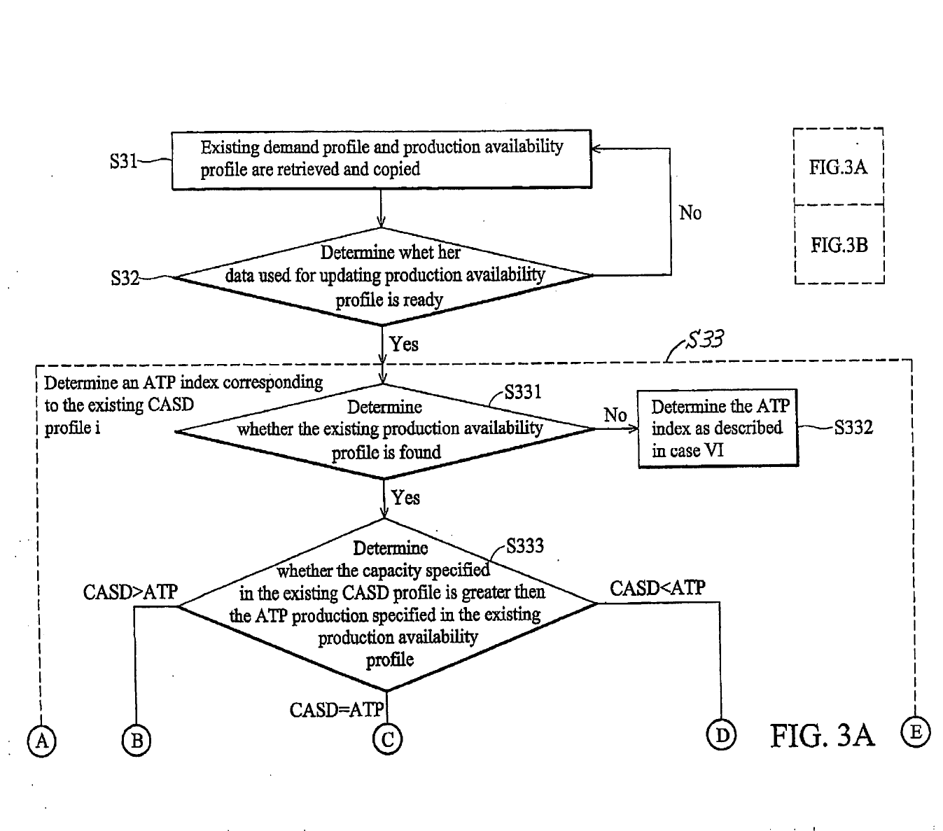

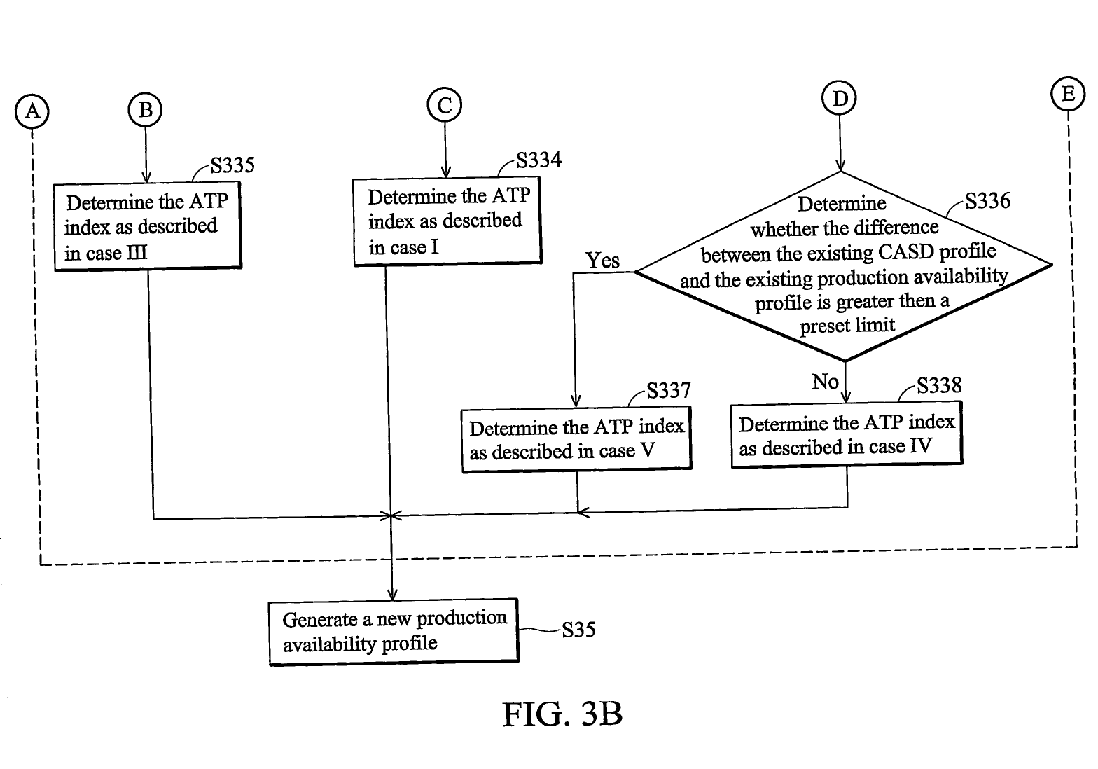

The processing algorithm implemented in processor 23 is detailed in the flowchart of FIG. 3.

In step S31, existing demand profile and production availability profile are retrieved and copied to the historical area 211 and temporary area 213 respectively. The demand profile may be a CASD profile, specifying the amount of capacity allocated support demand (CASD) for the client during a preset period, for example, one month. The CASD profile comprises a non-booked CASD value and a booked CASD value, wherein the non-booked CASD value specifies remaining CASD not booked by a placed order of a particular client. The production availability profile may be a production availability profile, specifying available-to-promise (ATP) production corresponding to the non-booked CASD. The production availability profile comprises production values specifying quantities of ATP production allocated to the client during different divisions of the preset period. For example, the Production availability profile comprises 4 production values specifying quantities of ATP production allocated to the client in 1˜4 weeks of the month. Data in the temporary area is used for a process updating the production availability profile. Data in the historical area 211 is used for providing an information service, such as a scheduling service, while the production availability profile updating process in progress. In step S32, it is determined whether data used for updating the production availability profile is ready, and if so, the method proceeds to step S33, otherwise, the method returns to step S31.

Data copied in step S31 and checked in step S32 pertains to a particular client identification number, manufacturing factory, manufacturing technology (micron group), and a preset period of time. According to this embodiment, the preset period of time is one month, and the CASD profile is determined on a monthly basis, while the ATP profile is determined on a weekly basis.

In step S33, an ATP index corresponding to the existing CASD profile is determined. The ATP index specifies ratios of production values of 1˜4 weeks within the month. In determining the ATP index, different algorithms are executed in response to different relationships between the existing ATP profile and existing CASD profile.

In step S331, it is determined whether the existing production availability profile is found, and if so, the method proceeds to step S333, otherwise, the method proceeds to step S332. If the existing production availability profile cannot be located, a new production availability profile is created for the client. If the existing production availability profile is located, the ratios corresponding to production values of 1˜4 weeks are used for updating production availability profile. In step S332, the ATP index is determined as described in case VI (detailed below). In step S333, it is determined whether the capacity specified in the existing CASD profile is greater then the ATP production specified in the existing production availability profile. If the capacity specified in the existing CASD profile is equal to the ATP production specified in the existing production availability profile, the ATP index is determined in step S334 as described in case I (detailed below). If the capacity specified in the existing CASD profile is greater then the ATP production specified in the existing production availability profile, the ATP index is determined in step S335 as described in case III (detailed below). If the capacity specified in the existing CASD profile is less then the ATP production specified in the existing production availability profile, it is further determined whether the difference between the existing CASD profile and the existing production availability profile is greater then a preset limit (step S336). The preset limit can be determined to meet special needs. In this embodiment, the preset limit is 500 wafers. If the difference between the existing CASD profile and the existing production availability profile is greater than or equal to 500 wafers, the ATP index is determined in step S337 as described in case V (detailed below). If the difference between the existing CASD profile and the existing production availability profile is smaller then 500 wafers, the ATP index is determined in step S338 as described in case IV (detailed below).

In step S35, a new production availability profile is generated according to the ATP index determined in step S33 and the existing CASD profile stored in the temporary area 213. The production values of the updated production availability profile are determined according to ratios of the production values of the existing production availability profile and the existing CASD profile.

The method is performed in response to newly received demand information or in response to a request. When an existing CASD is changed and/or a request is submitted, corresponding updated production availability information is determined in real time.

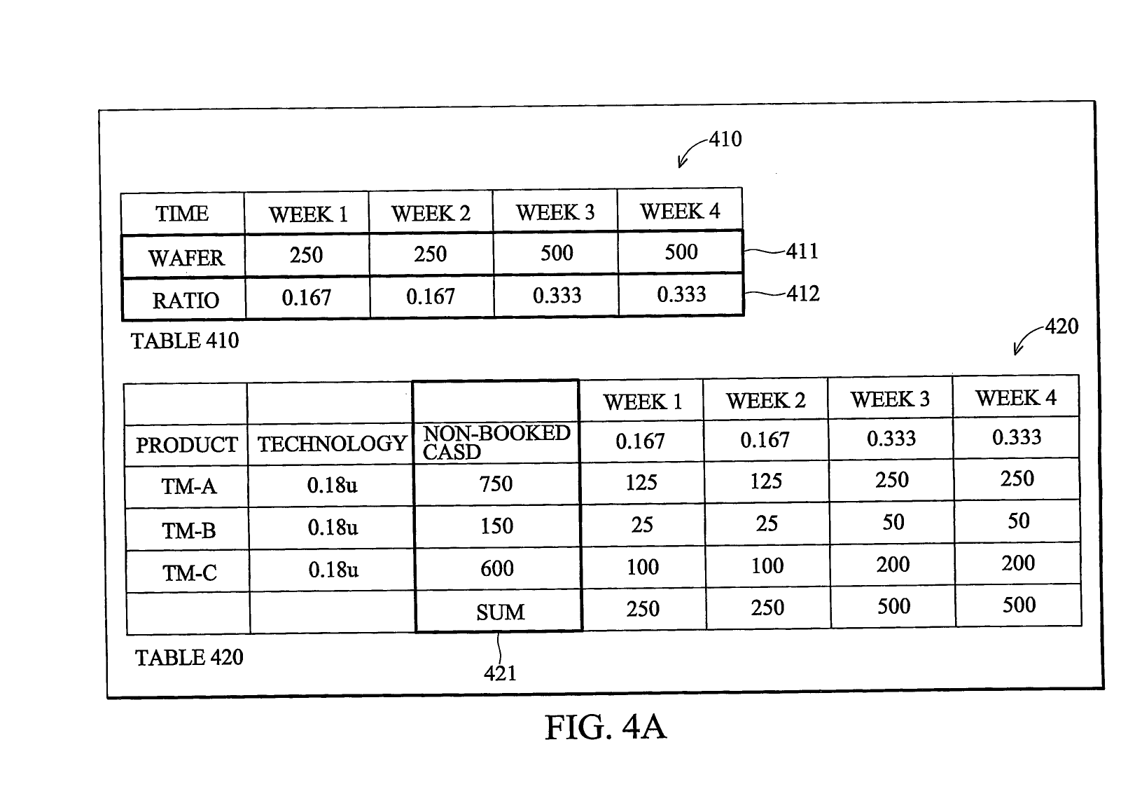

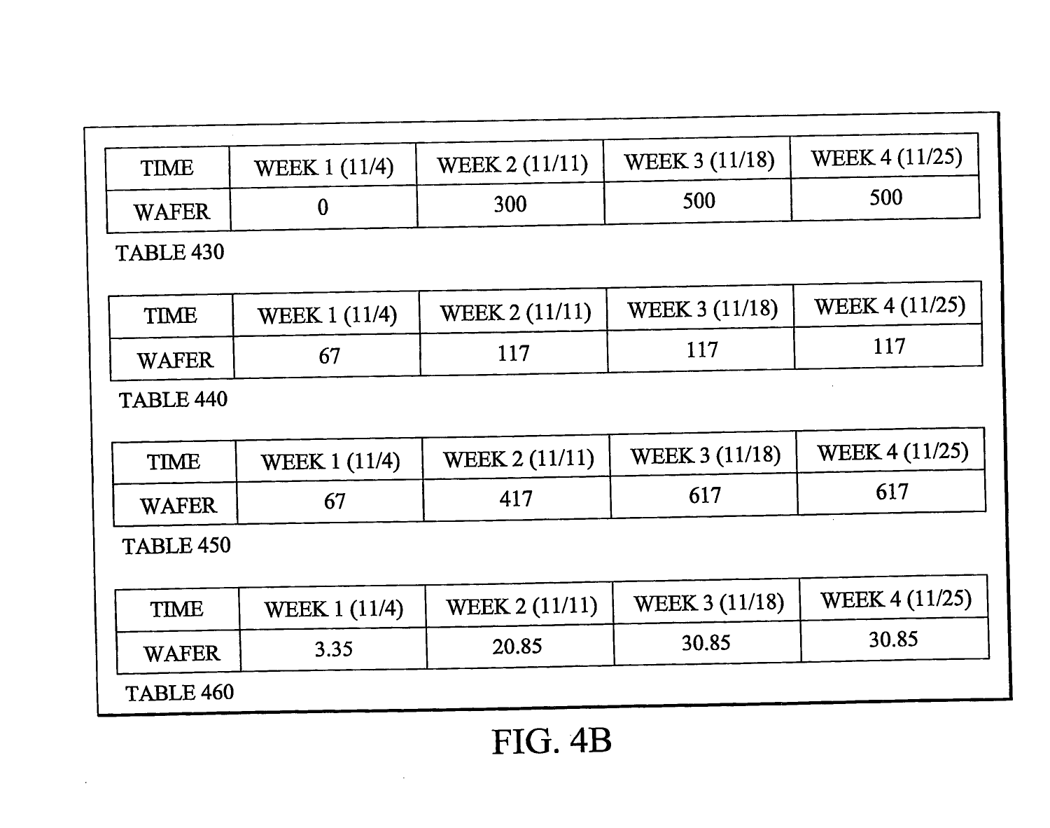

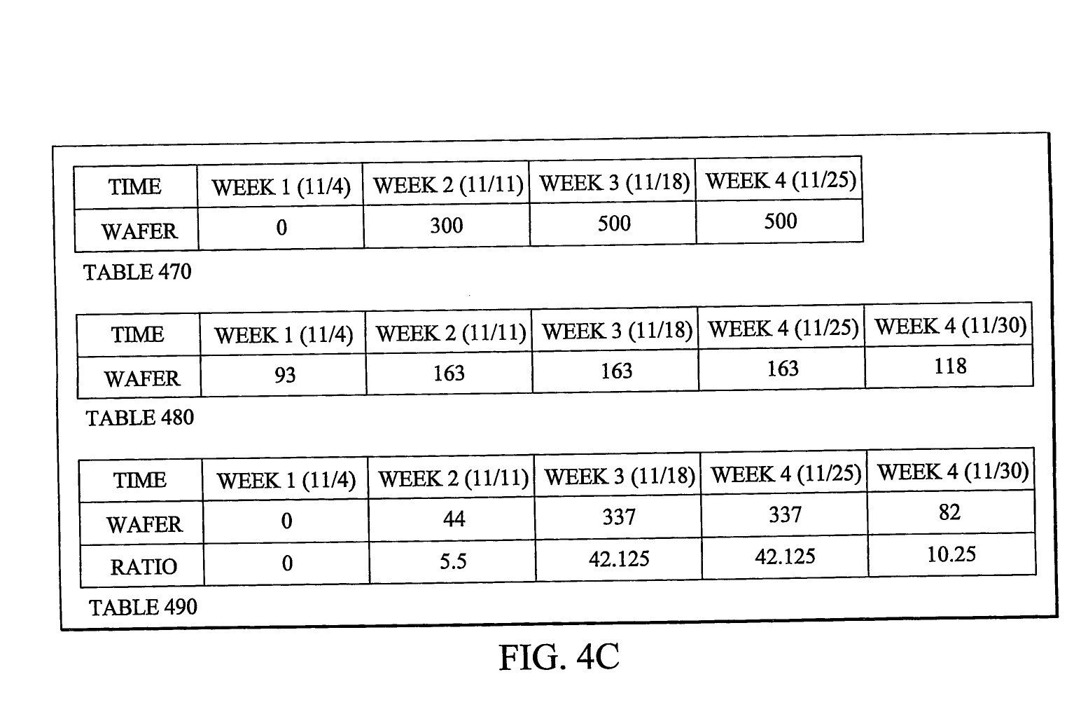

FIGS. 4A through 4D illustrate calculation processes of case I through VI of FIG. 3.

FIG. 4A illustrates an ATP index determination of case I. In case I, the capacity specified in the existing CASD profile is equal to the ATP production specified in the existing production availability profile. In other words, a CASD swap has occurred and the production availability profile is not updated accordingly. In case I, the ATP index is determined according to the ratios of production values of weeks 1˜4 within a month. Table 410 illustrates an existing ATP profile of client U001 for a 0.18 micron group production. An existing production availability profile is first retrieved from the temporary area 213. The production values of the existing production availability profile are 250, 250, 500, and 500 wafers, respectively, as shown in row 411 of table 410. The ratios of production values of weeks 1˜4 specified in the existing production availability profile are then calculated. The ratios of production values of weeks 1˜4 are 0.167, 0.167, 0.333, and 0.333, respectively, as shown in row 412 of table 410. The existing CASD profile is then retrieved from the temporary area. Table 420 illustrates ATP profile generation based on the existing ATP profile and CASD profile. The non-booked CASD values corresponding to all products within the same micron group are shown in column 421 of table 420. The capacity specified in the non-booked CASD of each product is then allocated to weeks 1˜4 according to the ratio values corresponding to weeks 1˜4 specified in the existing production availability profile. For example, capacity specified in the non-booked CASD of product ‘TM-A’ is allocated to week 1 through week 1 according to the ratio values corresponding to weeks 1˜4. The capacity allocated to product ‘TM-A’ is 750 wafers in total. Within the 750-wafer capacity, production values of 125, 125, 250, and 250 wafers are allocated to weeks 1˜4, respectively. Similarly, capacity specified in the non-booked CASD of product ‘TM-B’ is allocated to weeks 1˜4 according to the ratio values corresponding to weeks 1˜4. The capacity allocated to product ‘TM-B’ is 150 wafers in total. Within the 150-wafer capacity, production values of 25, 25, 50, and 50 wafers are allocated to weeks 1˜4, respectively. Similarly, capacity specified in the non-booked CASD of product ‘TM-C’ is allocated to weeks 1˜4 according to the ratio values corresponding to weeks 1˜4. The capacity allocated to product ‘TM-C’ is 600 wafers in total. Within the 600-wafer capacity, production values of 100, 100, 200, and 200 wafers are allocated to weeks 1˜4, respectively. The production values allocated to products of the 0.18 micron group in weeks 1˜4 are 250, 250, 500, and 500 wafers, respectively.

In case IV, the difference between the existing CASD and existing ATP is less than 500 wafers. In this case, a calculation process similar to case I is performed. The ratios of production values of weeks 1˜4 specified in the existing production availability profile are first calculated. The capacity specified in the existing non-booked CASD of each product is then allocated to weeks 1˜4 according to the ratio values corresponding to weeks 1˜4 specified in the existing production availability profile.

FIG. 4B illustrates the ATP index determination of case III. In case III, the capacity specified in the existing CASD profile is greater then the ATP production specified in the existing production availability profile. In other words, the CASD has increased and the Production availability profile has not been updated accordingly. In case III, the difference between the capacity specified in the existing CASD profile and the ATP production specified in the existing production availability profile is divided into 4 parts proportional to the number of working days of weeks 1˜4. For example, weeks 1˜4 comprise 4, 7, 7, and 7 working days, respectively. According to this embodiment, the difference between the capacity specified in the existing CASD profile and the ATP production specified in the existing production availability profile is 500-wafer production. The added 500-wafer production is then divided into four parts proportional to the number of working days of weeks 1˜4. The additional production allocated to each week is calculated as follows:

Week 1: 500*(4/30)=67;

Week 2: 500*(7/30)=117;

Week 3: 500*(7/30)=117;

Week 4: 500*(7/30)=117.

Table 430 illustrates an existing ATP profile of client U001 for the 0.18 micron group production in Fab 61. Tables 440˜460 illustrate ATP profile generation based on the existing ATP profile and CASD profile.

The production values of the existing production availability profile for weeks 1˜4 are shown in table 430 of FIG. 4B. The additional production values for weeks 1˜4 are shown in table 440 of FIG. 4B. The production values of an updated production availability profile are calculated by adding the additional production value to the existing production value, which is calculated as follows:

Week 1: 0+500*(4/30)=0+67=67;

Week 2: 300+500*(7/30)=300+117=417;

Week 3: 500+500*(7/30)=500+117=617;

Week 4: 500+500*(7/30)=500+117=617.

The updated production values for weeks 1˜4 are shown in table 450 of FIG. 4B. The updated ATP index is determined by calculating the ratios of the production values for weeks 1˜4, which is calculated as follows:

Week 1: 67/(1300+500)=3.35%;

Week 2: 417/(1300+500)=20.85%;

Week 3: 617/(1300+500)=30.85%;

Week 4: 617/(1300+500)=30.85%.

The updated ATP index is shown in table 460 of FIG. 4B. The capacity specified in the non-booked CASD of each product is then allocated to weeks 1˜4 according to the updated ATP index corresponding to weeks 1˜4, as described above.

FIG. 4C illustrates ATP index determination of case V. In case V, the capacity specified in the existing CASD profile is less than the ATP production specified in the existing production availability profile. In other words, the CASD has decreased and the production availability profile is not updated accordingly. In case V, the difference between the capacity specified in the existing CASD profile and the ATP production specified in the existing production availability profile is divided into 4 parts proportional to the number of working days of the weeks 1˜4. For example, weeks 1˜4 comprise 4, 7, 7, and 7 working days, respectively. According to this embodiment, the difference between the capacity specified in the existing CASD profile and the ATP production specified in the existing production availability profile is 700-wafer production. The added 700-wafer production is then divided into four parts corresponding to the production allocated to each week. The deduct production allocated to each week is calculated as follows:

Week 1(11/4): 700*(4/30)=93;

Week 2(11/11): 700*(7/30)=163;

Week 3(11/18): 700*(7/30)=163;

Week 4(11/25): 700*(7/30)=163;

Week 4(11/30): 700-93-163-163-163=118

Table 470 illustrates an existing ATP profile of client U001 for 0.18 micron group production. Tables 480 and 490 illustrate ATP profile generation based on the existing ATP profile and CASD profile. The production values of the existing ATP profile for week 1 through week 4 are shown in table 470 of FIG. 4C. The deduct production values for week 1 through week 4 are shown in table 480 of FIG. 4C. The updated production values for weeks 1˜4 are calculated by subtracting the deducted production value from the existing production value, which is calculated as follows:

Week 1(11/4): 0-700*(4/30)=0-93=−93;

Week 2(11/11): 300-700*(7/30)=300-163=137;

Week 3(11/18): 500-700*(7/30)=500-163=337;

Week 4(11/25): 500-700*(7/30)=500-163=337;

Week 4(11/30): 200-118=82

The production value for week 1 is lower than the deducted production value, and the deducted production value is subtracted from the production value of the subsequent week. Therefore, the updated production values for week 1 and week 2 are adjusted as 0 and 44, respectively.

The updated production values for weeks 1˜4 are shown in table 490 of FIG. 4C. The updated ATP index is determined by calculating the ratios of the production values for week 1 through week 4, which is calculated as follows:

Week 1: 0(1500-700)=0%;

Week 2: 44(1500-700)=5.5%;

Week 3: 337(1500-700)=42.125%;

Week 4: 337(1500-700)=42.125%;

Week 4(11/30): 82/(1500-700)=10.25%

The capacity specified in the non-booked CASD of each product is then allocated to weeks 1˜4 according to the updated ATP index corresponding to weeks 1˜4, as described above.

In case VI, the existing production availability profile cannot be located. In case VI, the capacity specified in the existing CASD profile is divided into 4 parts proportional to the number of working days of the weeks 1˜4.

The described ATP updating process does not calculate ATP production for all unfilled orders, and therefore less computing resource is required. Additionally, the described ATP updating process is performed whenever a request is submitted. This enables an ATP management system to operate in real time.

Various embodiments, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. Some embodiments may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

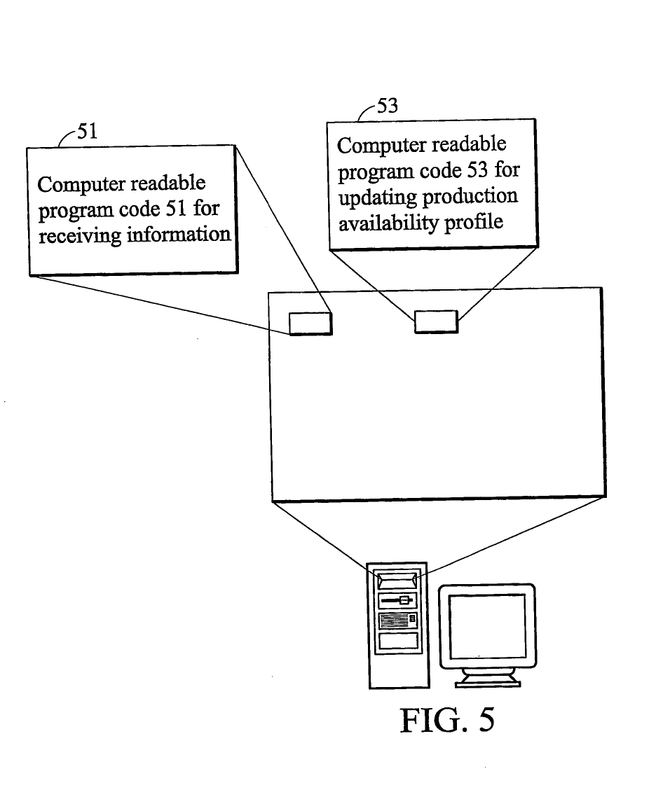

FIG. 5 is a diagram of a storage medium for storing a computer program embodying the method according to the present invention. The computer program product comprising a computer usable storage medium having computer readable program code embodied in the medium, the computer readable program code comprising computer readable program code 51 receiving information, and a computer readable program code 53 updating production availability profile.

The computer readable program code 51 receives a production entry corresponding to a client for production using a particular technology. The production entry comprises a demand profile and a production availability profile. The demand profile specifies amount of capacity allocated support demand (CASD) for the client during a preset period, comprising a non-booked CASD and a booked CASD. The production availability profile specifies available-to-promise (ATP) production corresponding to the non-booked CASD, comprising production values specifying quantities of ATP production allocated to the client during different divisions of the preset period.

The computer readable program code 53 updates an existing production availability profile according to an existing demand profile. The production values of an updated production availability profile are determined according to the existing CASD profile and ratios of the production values of the existing production availability profile.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A system for generating production availability in a production environment, enabling quick ATP generation from demand change to ATP profile update, comprising:
a storage device for storing a production entry for production using a particular technology, wherein the production entry includes:
a demand profile specifying an amount of capacity allocated support demand (CASD) during a predetermined period, comprising a non-booked CASD and a booked CASD; and
a production availability profile specifying available-to-promise (ATP) production corresponding to the non-booked CASD, comprising production values specifying quantities of ATP production allocated according to the request during different divisions of the predetermined period; and
a processor, connected to the storage device, for updating an existing production availability profile according to an existing demand profile, wherein the production values of an updated production availability profile are determined according to the existing demand profile and ratios of production values of the existing production availability profile.

2. The system of claim 1, wherein the processor, when updating the production availability profile, operates in response to a request using the existing production availability profile.

3. The system of claim 2, wherein the processor operates to provide a scheduling service.

4. The system of claim 1, wherein the existing production availability profile is updated according to the existing demand profile with an increased non-booked CASD.

5. The system of claim 1, wherein the existing production availability profile is updated according to the existing demand profile with a decreased non-booked CASD.

6. The system of claim 1, wherein the existing production availability profile is updated according to the existing demand profile having a swapped non-booked CASD, wherein the amount of capacity specified in the non-booked CASD does not change, and characteristics of capacity specified by the non-booked CASD has changed.

7. A computer implemented method for updating production availability, in a production environment, enabling quick ATP generation from demand change to ATP profile update, comprising:
providing a production entry for production using a particular technology, wherein the production entry includes:
a demand profile specifying an amount of capacity allocated support demand (CASD) during a predetermined period, comprising a non-booked CASD and a booked CASD; and
a production availability profile specifying available-to-promise (ATP) production corresponding to the non-booked CASD, comprising production values specifying quantities of ATP production allocated correspond to the entry during different divisions of the predetermined period; and
updating an existing production availability profile according to an existing demand profile, wherein production values of an updated production availability profile are determined according to the existing demand profile and ratios of production values of the existing production availability profile.

8. The computer implemented method of claim 7, further operating, while updating the existing production availability profile, in response to a request using the existing production availability profile.

9. The computer implemented method of claim 8, further operating to provide a scheduling service.

10. The computer implemented method of claim 8, further updating the production availability profile according to the existing demand profile with an increased non-booked CASD.

11. The computer implemented method of claim 7, further updating the production availability profile according to the existing demand profile with a decreased non-booked CASD.

12. The computer implemented method of claim 7, further updating the production availability profile according to the existing demand profile having a swapped non-booked CASD, wherein the amount of capacity specified in the non-booked CASD does not change, and characteristics of capacity specified by the non-booked CASD has changed.

13. A computer program providing a method for determining production availability in a production environment, enabling quick ATP generation from demand change to ATP profile update, the method comprising:
receiving a production entry corresponding to a client for production using a particular technology, and storing the production entry in computer-readable media, wherein the production entry includes:
a demand profile specifying an amount of capacity allocated support demand (CASD) correspond to the entry during a preset period, comprising a non-booked CASD and a booked CASD; and
a production availability profile specifying available-to-promise (ATP) production corresponding to the non-booked CASD, comprising production values specifying quantities of ATP production correspond to the entry during different divisions of the preset period; and
updating an existing production availability profile according to an existing demand profile, wherein production values of an updated production availability profile are determined according to the existing demand profile and ratios of production values of the existing production availability profile.

14. The computer program of claim 13, wherein the method further provides a scheduling service while updating the existing production availability profile, in response to a request using the existing production availability profile.

15. The computer program of claim 13, wherein the method further updates the production availability profile according to the existing demand profile with an increased non-booked CASD.

16. The computer program of claim 13, wherein the method further updates the production availability profile according to the existing demand profile with a decreased non-booked CASD.

17. The computer program of claim 13, wherein the method further updates the production availability profile according to the existing demand profile having a swapped non-booked CASD, wherein the amount of capacity specified in the non-booked CASD does not change, and characteristics of capacity specified by the non-booked CASD has changed.
